(19) United States
(12) Patent Application Publication
(10) Pub. No.: US 2016/0263493 A1
(43) Pub. Date: Sep. 15, 2016

(54) PORTABLE SEPARATOR UNIT FOR OIL WELLS

(71) Applicant: Kelly Maclaskey, Weatherford, TX (US)

(72) Inventor: Kelly Maclaskey, Weatherford, TX (US)

(21) Appl. No.: 14/645,191

(22) Filed: Mar. 11, 2015

(51) Int. Cl. B01D 17/02

(52) U.S. Cl. CPC B01D 17/0214

(57) ABSTRACT

A towable separator unit for oil wells has a walled enclosure with tanks therein. The tanks, which are an oil-water tank, a water tank and an oil tank, are separated from one another by interior side walls. An inlet pipe brings well fluids to the oil-water tank via a flume that allows the contents to enter the tank and be separated. A water leg allows water on the bottom to pass into the water tank; the water leg in contained inside the enclosure so as not to be subject to freezing. An oil outlet pipe allows oil on top of the oil water tank to exit and flow by gravity into the oil tank. The tanks have liquid level sensors therein; the levels are displayed on the outside and are transmitted to a remote location. The water and oil tanks have outlets. The oil tank has plural outlets arranged vertically to allow determination of the water level therein.

### SPECIFICATION

This application claims the benefit of U.S. provisional application Ser. No. 61/954,154, filed Mar. 18, 2014.

### FIELD OF THE INVENTION

The present invention relates to a separator unit for separating oil and water produced from oil wells.

### BACKGROUND OF THE INVENTION

in addition to oil, oil wells typically produce unwanted fluids such as water. As fluid is produced to the surface by the well, it is desirable to separate water from the oil at the well site, before the oil is transported or sold.

In the prior art, separator units and storage tanks are brought to the well site. This involves loading the separator unit onto a truck and trucking the unit to the well site. Likewise, storage tanks are loaded onto one or more additional trucks and the tanks are trucked to the well site. The separator unit and storage tanks are typically oversized. As a result, when trucked to the well site, special procedures are followed, such as using escorts warn motorists of the wide load. All of these trucks and special procedures add to the cost of transporting the equipment to and from the well site.

Once delivered to the well site, the separator unit is located relative to the well and the storage tanks are located relative to the well and the separator unit. Lines running from the well to the separator unit are plumbed, as are lines from the separator unit to the storage tanks. The setup and installation of the equipment is time consuming and laborious. Once installed, the well is produced into the separator unit and the water is stored in a storage tank. The oil is stored in a separate storage tank.

Thus, it is expensive to provide a well site with a separator and separate storage tanks for oil and water. Included in the cost is not lust the equipment, but the cost of installation and removal of the equipment. In some wells, the cost of such equipment may be too expensive relative to the production of the wells. For example, in small stripper wells, small quantities of oil are produced. Such wells may produce large amounts of water relative to oil and thus be in need of a separator and storage. Yet, the cost of installing and removing the equipment ma be prohibitively high.

There is a need for a less expensive, less labor intensive, and more ecological reflective designed portable test separator unit.

### SUMMARY OF THE INVENTION

A towable separator unit for oil wells, comprises a chassis, wheels rotatable mounted to the chassis so the chassis can be towed and a walled enclosure supported by the chassis. The enclosure has top, bottom, exterior side and end walls, the walled enclosure having interior side walls arranged so as to form a first tank, a second tank and a third tank, each of the first, second, and third tanks capable of holding a fluid without leaking. An inlet pipe is structured and arranged to connect to an oil well, the inlet pipe communicating with the first tank so as to deliver fluids from the oil well into the first tank. A first transfer pipe has an inlet located in a bottom region of the first tank. The first transfer pipe having an outlet located in one of the second or third tanks, the first transfer pipe located interiorly of the walled enclosure. A second transfer pipe has an inlet located in a top region of the first tank, the second transfer pipe having an outlet located in the other of the second or third tanks, the second transfer pipe sloped downwardly from its inlet to its outlet. Each of the second and third tanks having an outlet.

In accordance with one aspect, the first, second and third tanks are arranged longitudinally inside the walled enclosure, with the second tank between the first and third tanks.

In accordance with another aspect, the top wall of the walled enclosure has a step down portion that is stepped down from the first tank to the third tank the second transfer pipe is located exterior to the stepped down portion of the top wall, further comprising a valve in the exterior portion of the second transfer pipe.

In accordance with another aspect, the inlet pipe is connected to a flume located in the first tank, the flume extending vertically from the top wall toward the bottom wall, the flume having a lower portion with openings therein to allow the well fluid to enter the first tank, further comprising a perforated coalescer above the flume openings.

In accordance with another aspect, the first transfer pipe comprises a water leg.

In accordance with another aspect, the third tank has plural outlets arranged vertically along the third tank.

In accordance with another aspect, further comprising a level sensor in at least one of the first, second or third tanks, the level sensor providing liquid level information to a display on the exterior of the walled enclosure.

In accordance with another aspect, further comprising a wireless transmitter connected to the level sensor to provide level information remotely from the well.

In accordance with another aspect, the level sensor measures the level of oil and also measures the level of water in the respective tank.

In accordance with another aspect, wherein the inlet of the second transfer pipe comprises a stub removably connected to the second transfer pipe and having a length so as position the inlet of the second transfer pipe at a predetermined location above the bottom W all of the first tank.

In accordance with another aspect, the unit is road legal.

### BRIEF DESCRIPTION OF THE DRAWINGS

FIG. 1 shows the separator unit at a well site, connected to a well.

FIG. 2 is a side view of the separator unit, in accordance with a preferred embodiment.

FIG. 3 is a top view of the separator unit.

FIG. 4 is a rear end view of the separator unit.

FIG. 5 is a front end view of the separator unit.

FIG. 6 is a partial cross-sectional side view of the separator unit.

FIG. 7 is a side elevational view of the flume.

FIG. 8 is a side elevational view of the water leg.

FIG. 9 is a detailed side elevational view of the inlet to the oil transfer pipe.

FIG. 10 is a schematic view of a level sensor.

FIG. 11 is a block diagram of the sensor system.

FIG. 12 shows a liquid level sensor in accordance with another embodiment.

### DESCRIPTION OF THE PREFERRED EMBODIMENT

FIG. 1 shows an oil well site with an oil well 11. The oil well is a stripper well that produces a small quantity of fluid on a daily basis. Much of the fluid produced is oil, but a quantity of water is also produced. In order to separate the oil, and the water and store both types of separated fluids, a separator unit 15 is used.

The separator unit 15 is portable and fully self-contained. It is suitable for being towed on roads and simple to install and make ready for operation. Once in operation, the separator unit 15 is reliable with no active components such as pumps. Much of the plumbing is internal where it is protected from freezing and being damaged when the unit is towed on the road. Because little work needs to be done to set up and remove the separator unit 15 from a well site, the unit is safer to install and remove and is also safe to operate.

When no longer needed, the separator unit 15 can easily be disconnected and towed off of the well site and reused at another well site.

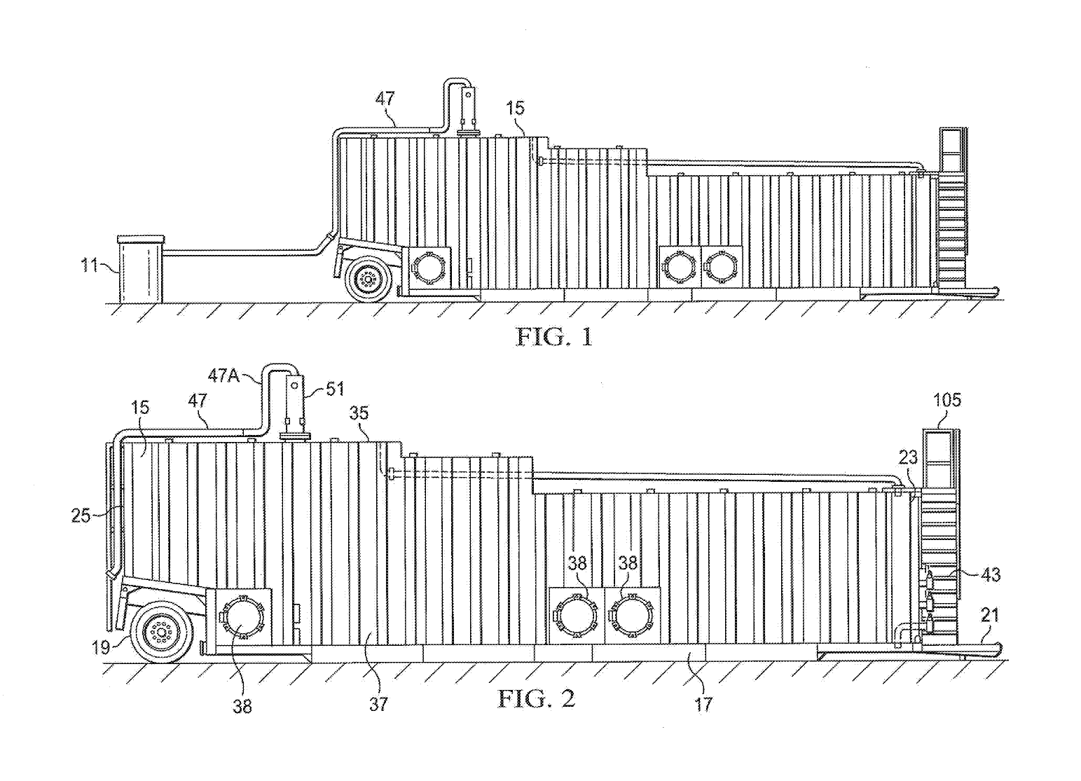

The separator unit 15 (see FIG. 2) is a self-contained trailer, having a chassis frame 17, wheels 19 and a towing hitch 21. The trailer has a front end 23 near the hitch, and a rear end 25 near the wheels 19.

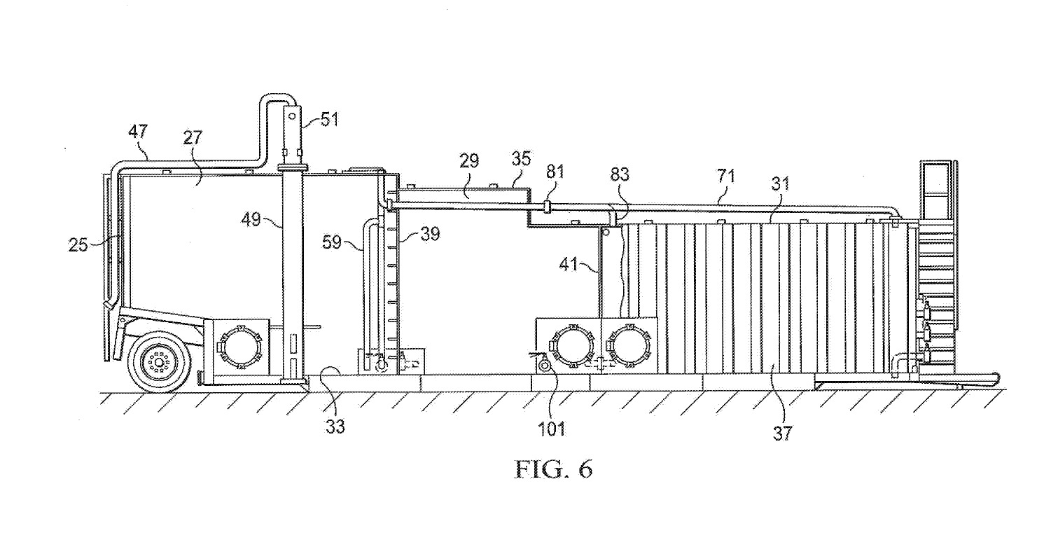

In addition, the separator unit has three tanks or compartments, namely an oil-water tank 27 (see FIG. 6), a water tank 29 and an oil tank 31. Each tank has a floor 33, a top 35 and exterior side walls 37. The exterior side walls 37 are corrugated. Each tank is provided with an access hatch 38 in the respective side wall. There are also interior side walls 39, 41 between the tanks. The oil-water tank 27 shares a side wall 39 with the water tank 29. The water tank 29 shares a side wall 41 with the oil tank 31. The interior surfaces of the tanks are epoxy coated.

In the preferred embodiment, the oil-water tank 27 is located at the rear end 25, the oil tank 31 at the front end 23 and the water tank 29 between the other two tanks. The oil-water tank and oil tank are about the same volume, while the water tank is smaller in volume, in the preferred embodiment. The relative sizes of the tanks can be changed to suit the particular needs of the well site. By way of example only, the oil-water tank can be 210 barrels, the oil tank 214 barrels and the water tank 150 barrels.

The top 35 of the unit is stepped down from the rear end 25 to the front end 23. The top of the oil water tank 27 is higher than the tops of the other two tanks 29, 31. The top of the water tank 29 is stepped down 79 at a location between the interior side walls 39, 41 (see FIG. 6). Steps 43 or a ladder can be provided at the front end 23 (see FIGS. 2 and 5) to allow personnel to access the top 35. The rear end 25 is equipped with lights 45 so that the trailer can legally travel on roads (FIG. 4).

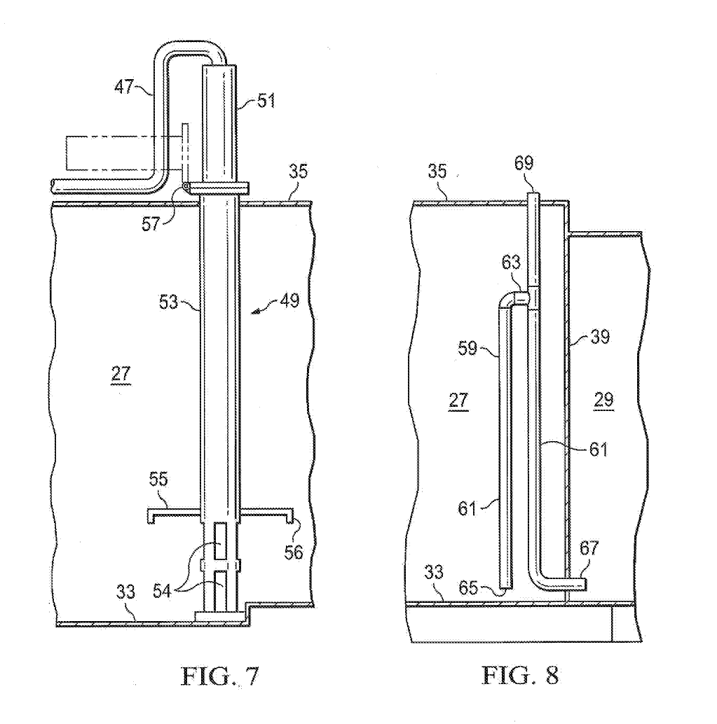

An inlet pipe 47 is connected to the oil-water tank 27. The inlet pipe 47 is connected to the well 11, either directly, or indirectly by way of equipment such as a gas separator. The inlet pipe 47 extends along the exterior of the rear end 25 and along the top 35 of the oil-water tank 27 to a vertical pipe or flume 49. Referring to FIG. 7, the flume 49 has an exterior or upper, portion 51 and an interior, or lower, portion 53. The interior portion 53 is a pipe that extends from the top 35 to the floor 33 of the oil-water tank 27. The top end of the pipe extends above the tank top 35 for a short distance. The pipe has cutouts or openings 54 in its tower end to allow the liquid in the pipe to escape into the tank 27. A spreader 55, or coalescer, is provided a distance above the floor 33. The spreader is located above the openings 54. The spreader 55 is attached to and extends out horizontally from the pipe. The spreader 55 is a perforated plate or mesh and could be made of expanded metal. The spreader can be a flat plate. If so, then the plate is provided with a downwardly depending skirt 56 that extends around the circumference of the plate. Alternatively, the plate can be domed, with the outer edges lower than the center. Thus, the oil and water is retained under the spreader for a period of time to allow the oil to coalesce. The lower portion of the flume 49 is located in the center of the lowest part of the tank 27.

The upper portion 51 stands up from the top 35 of the tank. The upper portion 51 is hinged 57 or otherwise movably coupled to the lower portion 53 top end. When the separator unit 15 is being transported, the upper portion 51 is laid down as shown b) dashed lines in FIG. 7 in order to reduce the overall height of the unit. As an alternative, the upper portion 51 can be completely removed and stowed in a bracket on the side of the unti in order to lower the overall height of the unit. Handles can be provided on the upper portion to assist in moving the portion into place. On installation, the upper portion 51 is raised to a vertical position and is secured to the lower portion 53 with one or more clamps. A gasket between the upper and lower portions provides a seal. The connection is preferably a quick release clamp with a single bolt. This is in contrast to a typically pipe flanged connection with a number of bolts. The quick release clamp saves time in setup and take-down. The inlet pipe 47 is connected to the upper portion 51. The inlet pipe 47 has a flexible portion 47A that extends from the top wall to the flume top 51 to accommodate the flume top 51 moving about the hinge.

Water is transferred from the oil-water tank 27 to the water tank 29 by way of a water leg 59 (see FIG. 8). The water leg 59 has an upside down “U” shape and is located in the oil-water tank 27. Thus, there are two vertical pipes 61 joined together by a horizontal pipe 63 which is located some distance above the floor 33. One end of one of the vertical pipes 61 is open 65 to the oil-water tank 27 and is located close to the floor 33. The other vertical pipe 61 joins to a horizontal pipe 67 which passes through the side wall 39 into the water tank 29 where it is open. A vertical riser 69 extends from one of the vertical pipes 61 above the top 35. A weather cover can be provided over the open riser 69.

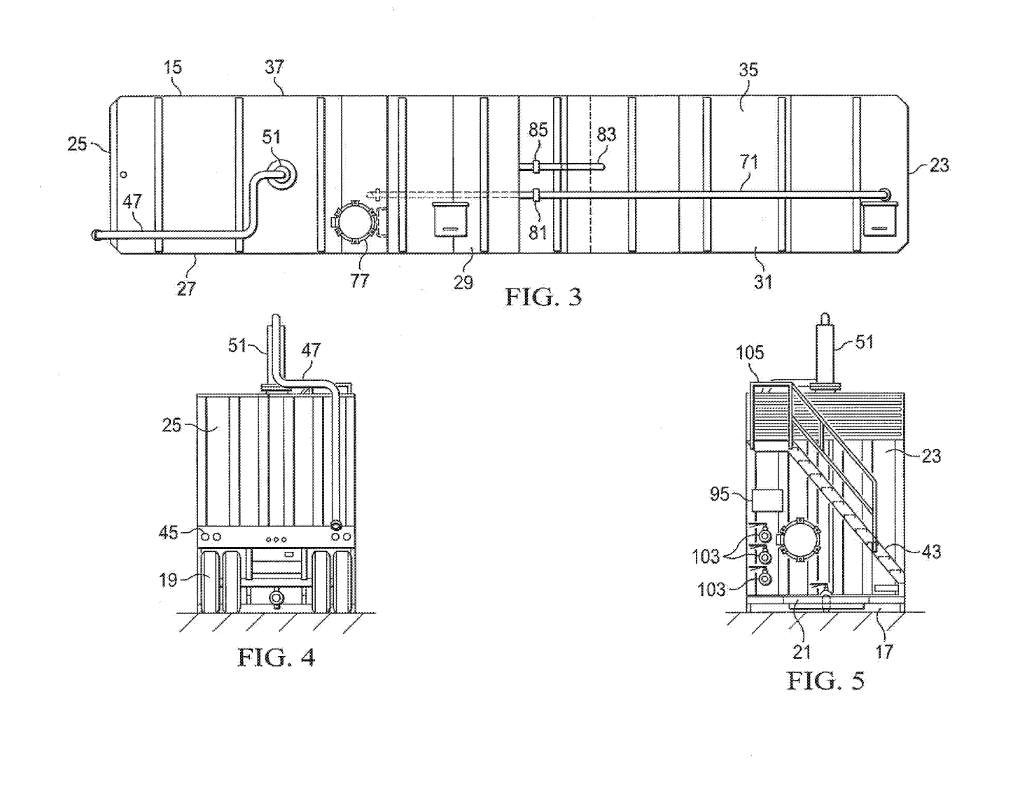

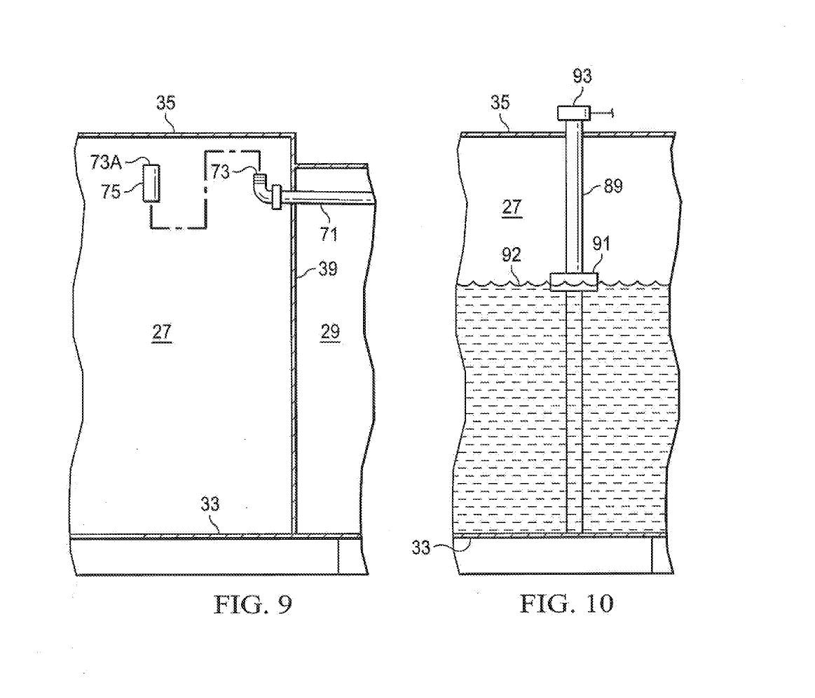

Oil is transferred from the oil-water tank 27 to the oil tank 31 by an oil transfer pipe 71. The inlet 73 to the pipe 71 is located near the top 35 of the oil tank 27 (see FIG. 9). The height of the inlet 73 above the floor 33 can be adjusted by adding or subtracting the lengths of vertical pipe stubs 75. For example, adding a pipe stub 75 on top of the pipe creates an inlet 73A that is higher relative to the floor 33. The stubs 75 can be threaded into the pipe 71. An access hatch 77 is provided on the top 35 in order to access the inlet 73 (see FIG. 3).

The oil transfer pipe 71 exits through the side wall 39, extends along the upper portion of the water tank 29 for a distance and exits the water tank at the step down partition 79. The pipe 71 continues along the top exterior toward the front end 33 where it enters the oil tank 31 at the top. The pipe is sloped down from the oil-water tank to the oil tank. A valve 81 is provided, which valve is accessed from the top 35 of the unit.

An overflow and skim oil pipe 83 is provided between the water tank 29 and the oil tank 31. The overflow pipe 83 (see FIGS. 3 and 6) has an inlet near the top of the water tank 29 and extends out of the water tank at the step down 79. The pipe 83 then enters the top of the oil tank 31. The pipe 83 is provided a valve 85, accessible from the top. Personnel can use the stairs 43 to climb on top and access the valves 81, 85 as well as access hatches.

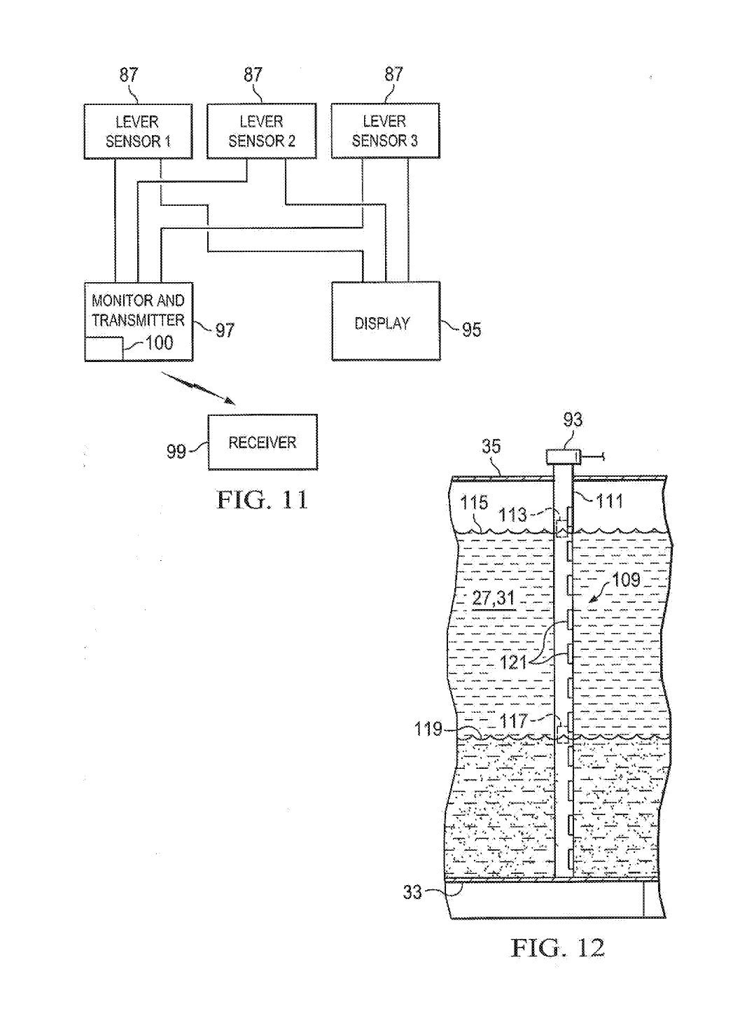

One or more tanks 27, 29, 31 are provided with level sensors 87 (see FIG. 10). The sensors are conventional and commercially available. A tube 89 extends vertically inside the respective tank through the top down to the bottom or floor. A toroid float 91 can travel along the tube and tracks the liquid level 92. As the float 91 moves, its position is detected by magnetic sensors inside the tube. In addition, the temperature of the fluid can be sensed by the unit. Electronic package 93 is located on top of the tube and sends the level and temperature information to a display 95 (FIGS. 11), which is mounted at the front end 23 (FIG. 5).

Referring to FIG. 11, the level sensors 87 report to a monitor 97 which electronically monitors the levels. If a level in a tank exceeds a predetermined level, the monitor 97 initiates an alarm. The alarm is provided on the display and is also sent offsite by a wireless communications link, such as a satellite link (or cellular telephone link). A receiver 99 located offsite receives the alarm. The receiver can be a cellular telephone or smartphone. The system allows offsite personnel to monitor the status of the unit 15 to minimize overflow from the tanks. In addition to sending alarm information, the system can also send status updates on the liquid levels and temperatures. These can be sent on a periodic basis. The system can include a GPS (global positioning system) unit 100. For example, the monitor and transmitter 97 can include a GPS unit 100, wherein the location of the separator unit 15 is transmitted to the receiver 99. The GPS unit 100 allows the separator unit 15 to be leased on a per location basis. If the unit is moved to another location outside of the terms of the lease (and without permission of the owner), the owner will know that the lease has been violated.

FIG. 12 illustrates another embodiment of a liquid level sensor 109. A vertical tube 111 is provided from the top wall 35 to the bottom 33. The tube has a longitundinal slot therein to allow liquid in the tank to enter the tube at various levels. Alternatively, the tube can be provided with a series of slots or openings along the length of the tube to admit liquid therein. Inside the tube are two floats that move along the length of the tube interior. One float 113 is on top of the oil 115, while the other float 117 is on top of the water 119. Also inside of the tube 111 are magnetic sensors 121 that sense the positions of the two floats 113, 117. The magnetic sensors are connected to the electronic package 93.

The sensor 109 is used in a tank having both oil and water. For example, one sensor 109 can be used in the oil-water tank 27 while another sensor 109 is used in the oil tank 31. The water tank 29 can be provided with the sensor 109, however typically the water tank contains little or no oil.

As the levels of liquid 115, 119 vary, the respective floats 113, 117 move along inside the tube, with the oil float 113 following the oil level 115 and the water float 117 following the water level 119. The positions of the floats are sensed by the sensors 121, which are read by the electronics package 93 and sent to the display 95 and the receiver 99.

The water and oil tanks 29, 31 have takeoff valves in the respective side walls 37. The water tank 29 takeoff valve 101 (see FIG. 6) is located near the floor or bottom of the tank. The valve 101 allows a hose to be connected thereto so that water in the tank can be loaded into a truck for transport offsite.

The oil tank 31 has a number of takeoff valves 103 (see FIG. 5) vertically staggered and located at the front end 23. Thus, the valves allow a user to sample the liquid inside at various vertical positions or vertical levels inside the tank. The oil inside the oil tank 31 is typically marketable. However, there may be some water located at the bottom. When an operator arrives to offload oil, the operator can open the various valves 103 to determine where the bottom level of the marketable oil is. For example, the operator can open the bottom valve. If water comes out or a combination of water and oil comes out, the operator knows that there is water at that particular level. The operator can open the next highest valve. If oil comes out of the valve, then the operator knows that oil is located at that level and above. Therefore, the operator would connect the hose to that valve, open a valve to offload the liquid oil for transport offsite.

In operation, the unit 15 is towed to a well site. The unit is road legal, with lights and with a width and a height that allows it to be taken on public roads and beneath bridges and overpasses. An escort for the towed vehicle need not be provided as the unit 15 is towed on public roads. This saves labor and expense. At the well site, the unit is positioned as desired. The unit is then lowered to the ground; the chassis 17 bears on the ground. The well is connected to the inlet pipe 47. The exterior portion 51 of the flume 49 is raised to a vertical position and clamped in place in addition, hand rails 105 can be installed on the landing, which hand rails have been taken off and stowed for transport As an alternative, the stairway landing can be lowered so as to lower the overall height of the hand rails 105, which hand rails can then be permanently attached. Hand rails can be permanently attached along the steps up to the landing. The truck towing the trailer is disconnected and can be used for other jobs. Once connected, the unit is ready for operation and the well can be opened to produce into the unit. Oil and water flow through the inlet pipe 47 and descend into the oil-water tank 27 via the flume 49. The liquid exits the flume through the openings 54 in the bottom. The water naturally stays at the bottom while the oil rises to the top. The spreader 55 slows the ascent of the oil and serves to coalesce small globules of oil into larger globules, which makes separation more effective. The flume 49 thus slows the velocity of the incoming liquid in order to assist in separation.

The overall fluid level in the oil-water tank 27 rises as liquid continues to enter. When the level is high enough, water passes from the bottom of the oil-water tank 27, through the water leg 59 and into the water tank 29. Likewise, oil enters, the oil transfer pipe 71 near the top of the oil tank 27 and flows into the oil tank 31. Thus, separation is accomplished automatically.

Overflow protection and skim oil capability is provided. For example, in the preferred embodiment, the water tank 29 is smaller in volume than the oil tank 31. If an operator, when onsite, and reading the display 95, notices the water level in the water tank is high and close to overflowing, the operator can open the valve 85 and allow water to exit the water tank 29 via the overflow pipe 83 into the oil tank 31. The operator is thus able to prevent a spill, which spill could have environmental consequences. Alternatively, if the water tank were larger than the oil tank, an overflow pipe could be provided, which allows flow from the oil tank into the water tank.

Although liquid level sensors can be provided in one or more of the tanks 27, 29, 31, sight glasses could be used as an alternative. Such sight glasses however are subject to breakage and, if filled with water, freezing.

The overflow pipe 83 can be used to transfer skim oil out of the water tank 29. The skim oil is at the top level of liquid in the water tank. An operator can open the valve 85 to transfer the skim oil out of the water tank 29 into the oil tank 31.

The separator unit is easy to install and set up, easy to remove from a well site and low in maintenance. It operates automatically, needing only occasional visits to offload the water and the oil, typically by truck. It is desired for cold climate use, as the water lines are all interior and not subject to freezing.

The separator unit can be operated and liquid levels monitored by personnel on the ground. Personnel need not climb on top to gauge liquid levels, but can read the levels on the display 95. The offload valves 101, 103 are provided at ground level.

To remove the separator unit 15 from the well site, the well is disconnected by disconnecting the line 47. Preferably, the tanks 27, 29, 31 are emptied into other vessels to reduce the weight of the unit 15. All protruding objects such as the flume top and handrails are stowed. A towing vehicle is backed to the unit and connected to the trailer hitch 21. As the unit front end is lifted onto the towing vehicle, the chassis 17 is lifted off the ground and the wheels 19 bear the weight. The unit 15 can now be towed on the wheels 19. Thus, the unit is both set up and removed simply and quickly, saving on labor and materials.

The unit 15 is road legal and is not an oversized load. As a result, one or more escorts for transporting the unit along a public road are not required. An example of a road legal load is a width not exceeding 102 inches and a height not exceeding 13 feet 6 inches. The unit 15 is within these dimensions.

Although the unit 15 can be used as a self-contained separator, in some situations, the unit can be used in conjunction with other equipment. For example, the unit can be used with a separate water tank, if the well produces too much water for the water tank 29 and additional water storage is needed. As another example, the unit 15 can be used with a separate oil tank, to provide additional oil storage on the well site.

The foregoing disclosure and showings made in the drawings are merely illustrative of the principles of this invention and are not to be interpreted in a limiting sense.

1. A towable separator unit for oil wells, comprising:
a) a chassis;
b) wheels rotatably mounted to the chassis so the chassis can be towed;
c) a walled enclosure supported by the chassis and having top, bottom, exterior side and end walls, the top, bottom, exterior side and end walls having exterior faces, the walled enclosure having interior side walls arranged so as to form a first tank, a second tank and a third tank, each of the first, second, and third tanks capable of holding a fluid without leaking, the first tank formed by at least the top, bottom and exterior side walls and one of the interior side walls, the third tank formed by at least the top, bottom and exterior side walls and another of the interior side walls, the interior side walls extending from the bottom wall to the wall, at least one of the interior side walls is common to two of the first, second or third tanks;
d) an inlet pipe structured and arranged to connect to an oil well, the inlet pipe communicating with the first tank so as to deliver fluid from the oil well into the first tank;
e) a first transfer pipe having an inlet located in a bottom region of the first tank, the first transfer pipe having an outlet located in one of the second or third tanks, the first transfer pipe located interiorly of the top, bottom, exterior side and end walls;
f) a second transfer pipe having an inlet located in a top region of the first tank, the second transfer pipe having an outlet located in the other of the second or third tanks, the second transfer pipe sloped downwardly from its inlet to its outlet;
g) each of the second and third tanks having an outlet.

2. The towable separator unit for oil wells of claim 1 wherein the first, second and third tanks are arranged longitudinally inside the walled enclosure, with the second tank between the first and third tanks, the second tank formed by at least the top, bottom and exterior side walls.

3. The towable separator unit for oil wells of claim 2 wherein the top wall of the walled enclosure has a step down portion that is stepped down from the first tank to the third tank, the second transfer pipe is located exterior to the stepped down portion of the top wall, further comprising a valve in the exterior portion of the second transfer pipe.

4. The towable separator unit for oil wells of claim 1 wherein the inlet pipe is connected to a flume located in the first tank, the flume extending vertically from the top wall toward the bottom wall, the flume having a lower portion with openings therein to allow the well fluid to enter the first tank, further comprising a perforated coalescer above the flume openings.

5. The towable separator unit for oil wells of claim 1 wherein the first transfer pipe comprises a water leg, which water leg comprises a first vertical portion and a second vertical portion, the first and second vertical portions contained in the same tank.

6. The towable separator unit for oil wells of claim 1 wherein the third tank has plural outlets arranged vertically along the third tank.

7. The towable separator unit for oil wells of claim 1 further comprising a level sensor in at least one of the first, second or third tanks, the level sensor providing liquid level information to a display on the exterior of the walled enclosure.

8. The towable separator unit for oil wells of claim 7 father comprising a wireless transmitter connected to the level sensor to provide level information remotely from the well.

9. The towable separator unit for oil wells of claim 7, wherein the level sensor measures the level of oil and also measures the level of water in the respective tank.

10. The towable separator unit for oil wells of claim 1 wherein the inlet of the second transfer pipe comprises a stub removably connected to the second transfer pipe and having a length so as position the inlet of the second transfer pipe at a predetermined location above the bottom wall of the first tank.

11. The towable separator unit for oil wells of claim 1 wherein the unit is road legal.

12. The towable separator unit for oil wells of claim 4 wherein the flume further comprises a top portion located exteriorly of the top wall, the top portion movable between a stowed position, wherein the top portion is nonvertical, and an erect position, wherein the top portion is vertical.

13. The towable separator unit for oil wells of claim 10 wherein the stub is a first stub having a first length, further comprising a second stub having a second length that is different than the first stub, the second stub removably connected to the second transfer pipe when the first stub is removed therefrom.

14. The towable separator unit for oil wells of claim 1 wherein the exterior side and end walls are corrugated.

15. The towable separator unit for oil wells of claim 1 wherein the inlet pipe has a first portion extending along an outside of one of an exterior side or end wall of the walled enclosure, the inlet pipe having a second portion extending from the first portion along an outside of the top wall of the walled enclosure toward an opening in the top wall.
